(19) United States
(12) Patent Application Publication
(10) Pub. No.: US 2026/0247140 A1
(43) Pub. Date: Aug. 20, 2026

(54) CIPHER ARITHMETIC-BASED COMMUNICATIONS SYSTEM

(71) Applicant: James Butler, Herndon, VA (US)

(72) Inventor: James Butler, Herndon, VA (US)

(21) Appl. No.: 19/057,970

(22) Filed: Feb. 19, 2025

(51) Int. Cl. H04W 12/033

(52) U.S. Cl. CPC H04W 12/033

(57) ABSTRACT

A cipher communication system. A transmitting message source system is programmed to receive, store and transmit a message. A transmission cipher communications processor is programmed to receive the message from the message source system and programmed to mathematically transform the message into a ping for transmission. A radio transmitter receives the ping from the transmission cipher communication processor and forwards it to a transmit antenna for transmission. A receiving antenna receives the ping from the transmission antenna and forwards the ping to a radio receiver. The radio receiver receives the ping from the receiving antenna and forwards it to a receiving cipher communications processor that is programmed to receive the ping from the radio receiver and programmed to mathematically re-generate the original transmitted message based on the ping. In a preferred embodiment, the ping is transmitted for only a very short duration, allowing for very secure transmission. In preferred embodiments the present invention is utilized for secure maritime, terrestrial, subsea, airborne and space communications, as well as other applications.

The present invention is related to communication systems, and, in particular, to secure communication systems.

### BACKGROUND OF THE INVENTION

In the prior art digital communications includes a multitude of formats, coding, modulation techniques, spreading, and multiple access schemes. Different communications schemes are used in different bands of the frequency spectrum; however, generally the information follows the same process with options. The information (voice, data, video) is formatted into a bit stream; encoded (analog to digital if needed (A2D)); encrypted; channel encoded (error correction coding (ECC)); multiplexed with other sources; multiplexed data may be interleaved (scrambled) to minimize interference impacts; modulated; frequency spread; enrolled in a multiple access scheme; transmitted including mixing with an intermediate frequency (IF) and up conversion to the intended frequency; and passed through the channel via an amplifier and antenna. The receiver collects the signal via an antenna and low noise amplifier and down converts to an IF; the signal is selected out of the multiple access scheme; frequency de-spread; demodulated; de-interleaved; demultiplexed; channel decoded (ECC); decrypted; decoded (digital to analog (D2A)); and the information is retrieved from the format and sent to its destination. Common RF communications systems transmit in HF, VHF, UHF, L, S, C, Ku, Ka bands. Common optical communications transmit around 850, 1310 and 1550 nm. Acoustic communications transmit through the water between 2-6 KHz.

### RF Communications

Historically, RF communications have used analog modulation methods developed for radio communications including AM and FM for audio and television broadcast. Digital communications have evolved significantly from ASCII encoded teletype messaging through 5G wireless, satellite communications or those intended for deep space. RF communications may be through electrically conducted cable or over the air (OTA). There are numerous modulation schemes, protocols, and error correction coding techniques to ensure voice, video, and data arrive with the minimum number of errors. More recently, ASK, FSK, PSK, BPSK, QAM (16-256), Orthogonal Frequency Division Multiplexing (OFDM), and Direct Sequence Spread Spectrum (DSSS) are used in modern RF communications systems. Numerous protocols exist including 3G WCDMA, 4G, 5G, PDH/SDH, and Bell standards for microwave and cable-based communications. Common RF communications systems transmit in HF, VHF, UHF, L, S, C, Ku, Ka bands. The US Military and Government also use VLF, Military Ka, and higher bands such as V band for space.

### Acoustic Communications

Historically, acoustic (subsea) communications have used modulation methods developed for radio communications including AM and FM for voice. More recently, FSK, PSK, FHSS, DSSS, PPM, FPPM, MSK, and OFDM have been used for the transmission of digital data (including digitized voice). Most recently, NATO has adopted the JANUS standard for underwater communications. JANUS uses Frequency-Hoped (FH) Binary Frequency Shift Keying (BFSK). The binary data is modulated on 13 continuous waveform tones occurring in time windows. Frequencies are evenly spaced and a chip duration and frequency slot width are calculated from upper and lower boundaries. Cyclic Redundancy Check (CRC) coding identifies errors and the communications are re-allocated to frequency tones with less interference. The ultimate goal is plug and play connectivity across all users.

### Optical Communications

Historically, optical communications travel through terrestrial fiber cable, subsea fiber cable, and line-of-site free space optics. Typically, communications are sent on optical wavelengths of 850 nm, 1310 nm, and 1550 nm. Over fiber, multiple signals are also sent simultaneously using dense wavelength division multiplexing (DWDM) with up to 160 wavelengths between 1530 and 1625 nm. Data rates range from 155 Mbps up to 100 Gbps for each wavelength. Current protocols include Fiber Channel, InfiniBand, SDH, SONET, and Gigabit Ethernet (Gbe). The last three are commonly used today. Telephony voice and IP traffic are multiplexed and embedded in the protocol frames. The bits within frames may be encrypted. The frames are often scrambled and error correction coding applied to recover bit errors. Although phase shift keying has been used, On-Off Keying (OOK) is the primary modulation technique for fiber optic and free-space optical (FSO) communications.

Communicating via a constant stream of bits over an RF, Acoustic, or Optical channel works well but consumes the channel. The channel may be shared using multiplex schemes; however, when the signal is on the air, other assigned users must wait. Military and Government communications are prone to detection, intercept, exploitation (if not well encrypted), geo-location, and interference or jamming by and adversary or unintentional interference. There are multiple approaches and protecting communications; however, the longer a signal is on-air, the more susceptible the users are to adversaries and interference. Finally, the communications spectrum will be stressed during a large military action such as a war or conflict where there are large numbers of military units in an area of operations.

What is needed is a better, more efficient and secure communication system.

### SUMMARY OF THE INVENTION

The present invention provides a cipher communication system. A transmitting message source system is programmed to receive, store and transmit a message. A transmission cipher communications processor is programmed to receive the message from the message source system and programmed to mathematically transform the message into a ping for transmission. A radio transmitter receives the ping from the transmission cipher communication processor and forwards it to an transmit antenna for transmission. A receiving antenna receives the ping from the transmission antenna and forwards the ping to a radio receiver. The radio receiver receives the ping from the receiving antenna and forwards it to a receiving cipher communications processor that is programmed to receive the ping from the radio receiver and programmed to mathematically re-generate the original transmitted message based on the ping. In a preferred embodiment, the ping is transmitted for only a very short duration, allowing for very secure transmission. In preferred embodiments the present invention is utilized for secure maritime, terrestrial, subsea, airborne and space communications, as well as other applications.

### BRIEF DESCRIPTION OF THE DRAWINGS

FIG. 1-2 show a preferred embodiment of the present invention.

FIG. 3-27 describe to operation of a preferred embodiment of the present invention.

FIG. 28 shows to utilization of a preferred embodiment of the present invention.

### DETAILED DESCRIPTION OF THE PREFERRED EMBODIMENTS

The present invention provides a cipher communication system in which cipher communications are largely off-air with the exception of the short marker pings directing the edge calculation of the message. This frees up spectrum for more users and reduces noise and interference. Channel capacity is no longer limited by the Shannon Limit maximum bit rate based on frequency. In theory, gigabyte files may be sent via HF communications at an effective communications bit rate much more than the kbps rates available in HF communications today.

The cipher communications of the present invention are difficult to accurately geo-locate due to the short on-air time. Furthermore, a multiplexing scheme may reduce the number of pings over the air to just one per message. The communications are difficult to intercept due to the random nature of the signaling in time and the pings may be on separate frequencies. It is also difficult to intercept and exploit since the message is not transmitted, it is calculated. An adversary would need to know the calculation to be performed, the clock speed, padding, encryption keys, and encoding scheme. Without clock speed, they will not be able to determine where each bit and byte sits within the message. Exploitation is also difficult because these messages are file or block encrypted in memory. Exploitation is also difficult because an adversary does not have a known file of bits and bytes to attempt to brute force break the encryption.

The cipher communications of the present invention are less susceptible to interference and jamming. A single ping will be detectable above the noise floor or power increased to overcome the interference, especially in RF and Acoustic communications.

Cipher communications are more power efficient for transmission through the spectrum since the marker pings will be off air most of the time. This will reduce power consumption and heat in the amplification chain and extend the life of the equipment since it is not constantly transmitting bits. Power consumption is traded for edge calculation and computing instead at likely much less energy.

Fiber optic communications systems also benefit from less optical amplifiers in the chain. A higher power ping will go further in fiber optics and require less power gain in an optical amplifier as it passes through.

### Cipher Communications Architecture Overview

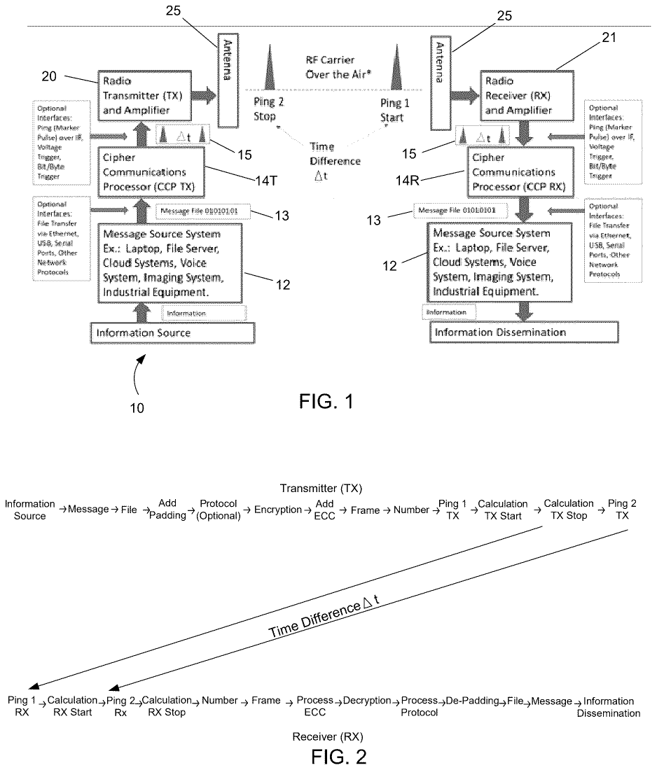

FIG. 1 outlines the basic architecture of preferred cipher communications system 10 in which messages are recreated at via a Cipher Communications Processor (Transmitter) 14T through mathematical calculations (ciphering) instead of transmitting the information bits in over the air radio frequencies (RF) (or through other mediums) as in the prior art. For example, in a preferred embodiment, a message is initially created via a message source system 12. Cipher Communications Processor (Transmitter) 14T is inserted as a separate device between the message source and the radio system (including radio, amplifier chain, and antenna). In another preferred embodiment, the cipher communications processing could be designed into a radio system, such as within a software defined radio (SDR) that meets compute, memory, and clock-management specifications.

Message information generated by a user or automated system via message source system 12 may consist of voice, video, data, images, text, data files, or even frames of bits and bytes from other network technologies to be relayed. When actively generated, the information is accumulated or collected into a Message and represented in the correct data format. When the message is completely formed, it is stored in a file 13. As an example, in the case of a voice system, analog voice would be digitized and stored as file 13 on the message source acting a server. In one preferred embodiment, file 13 is an ASCII-8 text message.

Message source 12 transfers file 13 to Cipher Communications Processor (Transmitter) 14T which mathematically edge processes (ciphering) file 13 and generates marker signals or pings 15 that instruct the CCP on the receiving end to mathematically recreate the file in memory. Common interfaces from the Message Source may be file transfer via ethernet, universal serial bus (USB), parallel serial ports, or other common network connection technologies.

Cipher Communications Processor (Transmitter) 14T stores the transferred file in its memory, conducts addition communications processing to create a frame, and then converts the frame, exclusive of its original contents, to a very large number for mathematical processing. Cipher Communications Processor (Transmitter) 14T begins the process by first transmitting ping 15 to the radio transmitter 20. When the receiving Cipher Communications Processor (Receiver) 14R detects the first ping, it begins a similar mathematical process to begin to recreate an identical frame in its memory. When the mathematical processing (ciphering) is complete, a second ping is generated and sent through the radio system to instruct the receiving Cipher Communications Processor (Receiver) 14R to stop the calculation and further process the frame back into its original file for forwarding. In a preferred embodiment, interface with radio transmitter 20 may include an intermediate frequency carrier (IF) to carry the marker signal (ping) or a trigger to tell the radio to send the ping. Electronically, at the integrated circuit (IC) or board level, a voltage threshold, bit, or byte may act as the trigger to tell radio transmitter 20 to transmit the ping. In the first example, transmits the ping to radio transmitter 20 through an internally generated IF carrier.

When transmitting marker signals or pings, Cipher Communications Processor (Transmitter) 14T imprints a pulse via pulse amplitude modulation onto an internal, IF carrier. When radio transmitter 20 receives the ping via IF carrier, it up converts the ping to the intended communications frequency such as HF, VHF, UHF, or other communications bands. The marker signal (ping) is amplified and transmitted through antenna 25 over the air to receiving antenna 25. The received signal is amplified as necessary and passed to receiving radio 21. Receiving radio 21 converts the RF signal to the IF carrier with the ping and passes it to receiving Cipher Communications Processor (Receiver) 14R. In this communications architecture, the RF carrier is not continually transmitting like other communications technologies, but only active when transmitting a ping, for the length of the ping in the time domain. The radio system (radios, amplifiers, antennas) transmits each ping at the time Cipher Communications Processor (Transmitter) 14T produces the pings with the same time difference (delta t) with no added time differential or delay. This ensures that the mathematical processing recreates the frame with a minimal number of bit errors.

When receiving radio 21 passes the pings via the IF carrier, the first ping starts a mathematical calculation, recreating the frame in Cipher Communications Processor (Receiver) 14R memory. The second ping stops the calculation. Cipher Communications Processor (Receiver) 14R conducts additional communications processing on the frame to extract the original file which resides in its memory.

The file is transferred to the message source (example: file server) and then the information message is forwarded or disseminated to the appropriate system. In this example, an ASCII text message is made available as a military message, news source, or other information.

As shown in FIG. 1, cipher communications system 10 may be applied to different transmission mediums including terrestrial RF, satellite RF, acoustic (subsea), audio (sound), optical, and even visual. Cipher communications system 10 can be applied to terrestrial and skywave RF communications systems and frequencies such as VLF, HF, VHF, UHF, or higher microwave transmission frequencies (300 MHz to 300 GHz). In the RF domain, the architecture may also be applied to satellite communications systems and frequency bands such as L, S, C, K, Ka, Mil KA, and higher. Cipher communications system 10 may be applied to optical communications systems in transmission mediums such as free space optics (FSO) or optical fiber cable systems. In the optical case, the ping will be up converted or imprinted onto an optical carrier such as a 1550 nm laser. The architecture can be applied to audio (sound-based) communications in which a sound-based marker signal ranging from 20 Hz to 20 KHz (or higher) is used to start and stop the cipher communications. Cipher communications system 10 can also be applied to the acoustic domain for subsea or underwater communications. In the acoustic case, the ping will be down converted or imprinted onto an acoustic carrier approximately within the 1-100 KHz range and transmitted using a transducer typically used in sonar systems. Finally, cipher communications system 10 may be applied to visual communications techniques such those used by maritime navies including semaphore flag signaling, hoisted signal flags, or flashing light. Instead of a signalman passing individual characters (letters and numbers) via semaphore signal (hand) flags, they simply start the calculation with a single semaphore flag signal aided by a cipher communications processor and stop the calculation with another semaphore flag signal at the appropriate time.

### Definition of Terms

Cipher Communications—the methodology of communicating messages by transmission and reception through calculating the message at both ends through algorithms and start and stop signal markers, not by directly modulating bits.
Cipher Communications Architecture—a larger architecture of communicating multiple messages through a variety of systems and nodes using the cipher communications methodology including hardware, software, and system elements. FIG. 1 is a simple example of the architecture.
Cipher Communications System—an end-to-end communications system assembled from both off-the-shelf components and detailed intellectual property following the Cipher Communications Architecture outlined in FIG. 1.
Cipher Communications Processor (CCP)—a dedicated processor accomplishes the functions for cipher communications. It may be an individual processing device that sits between the message sourcing system (such as a file server) and the rest of a communications system such as a radio, amplifier, and antenna chain. Alternatively, the CCP electronics and software may be embedded within the communications system such as an additional card or additional functionality with a software defined radio.
Cipher Modulation—the process of impressing the marker signal (nicknamed a ping) onto a carrier or otherwise encoding it into the spectrum. Spectrum includes radio frequency (RF), acoustic (audible or underwater), optical (lasers, led, free space optics or fiber optics), or visual (flashing light, signalman, flag hoist). The process of this modulation is further described a cipher shift keying.
Cipher Shift Keying (CISK)—details of the modulation approach in the signal in spectrum.
   Historically, “keying” terminology derives from early telegraph Morse Code keying and the key tapped on to generate the morse code signal.
   Keying Modulation may take the form of Amplitude, Frequency, Phase, on-off keying, or hybrid of modulation methods such as Quadrature Amplitude Modulation (QAM).
   In this approach, a Cipher-Derived Shift is created by a real-time calculation that generates or recreate a bits and bytes representation of the message across a non-contiguous, significantly-distant, differential in time, frequency, phase, or vector (of time and frequency).
   The difference from other basic digital modulation or keying method is the sending of markers to initiate and cease the cipher calculation vice actual bits and bytes sent over the air (or other medium).
Signal—the marker or markers passing through the spectrum that mathematically generates the frame and message. The simplest example is a Ping or short amplitude modulated pulse or Pulse Amplitude Modulation equivalent.
Ping—short name for a short, modulated signal marker that starts and/or stops the endpoint calculation. The modulated Cipher Shift Keyed signal may be a simple Pulse Amplitude Modulation, radar pulse, other modulation schemes (ASK, FSK, etc.) or a small number bits within a modulation scheme where a shift from a 0->1 represents the marker.
Message—inclusive of all types of transmitted communications including voice, video, data, and other (entire) network technology protocol frames relaying the messages in other communications and network architectures.
   Network protocol frames from other networking technologies (switches, routers, etc.) is specifically called out in case the system application calls for a relay of each frame without switching, routing, or other payload manipulation. For example, a SONET or Ethernet frame may be sent in its entirety and simply switched or routed without any additional network processing by the end points. Message is the representation, signal is what flies through the medium (air, water, fiber, cable, etc.). Examples of other network frames include Ethernet, Gigabit Ethernet, SONET/SDH, Bell/PDH standards, native TCP/IP, and even military tactical Link(s) 4/11/16/22. These other network frames carry internal payloads of voice, video, data (including TCP/IP) traffic.
Frame—the bits and bytes that make up a communications frame based on the protocol being used. Other communications technology frames include: Optical—SONET/SDH; Cable and Microwave Systems—Bell/PDH; WAN and LAN—Ethernet Gigabit Ethernet (GbE), 10/100/1000 Based-T; Tactical Links—Link 4/11/16/22. Components of the Frame include the message payload, Protocol bits and bytes, and correction coding (if used).
Cipher Communications Frame—This frame houses a fixed, maximum number of message bits, additional protocol bits, and encoding bits that in total are represented by each signal transmitted (marker/ping endpoints) and calculated within the CCP.
Medium—transmission spectrum the signal passes through. For cipher communications, the intended mediums include:
   RF—over the air and through space
   Optical—Free Space Optics over, air, space, through water, and fiberoptic cable
   Acoustic—through water, subsea communication and audio signals passing through air
   Visual—through visual signaling such as flashing light, semaphore (hand-flag), and hoisted signal flags
Embedded Protocol—protocol bytes appended to the message used for file type; accuracy; message re-assembly; multiplexing and access schemes; acknowledgment requirements; rotation to new communications plans; and encryption. Protocol management allows for dynamic software defined communications. Protocol and the frames may be altered as necessary for software defined networking as well.
   Protocol Message Concept Bytes (bytes (B)):
Protocol Header (1 B)—header start, SOH or equivalent
Frame number (1 B)—of this message for reassembly (256 max, expandable)
Number of message frames (1 B)—for reassembly (256 max, expandable)
Time Stamp (6 B)—six bytes, representative of actual time in Coordinated Universal Time (UTC) HH:MM:SS
Message Type (1 B)—voice, video, data, network frame, *.pdf, *.txt, *.docx, *.jpg, etc. ACK/NAK Message, etc. (0 NUL/NA, 1 Text, 2 JPEG, . . . )
Acknowledge Requirement (1 B)—ACK Yes, NAK No
Padding Plan (1 B)—one byte representing the actual padding byte, NUL or equivalent
Error Correction Coding (1 B)—representative of the ECC bytes outside of the encrypted file, or pre-planned ECC identifiers passed separately, used for maintenance
Next Plan (1 B)—preplanned directing the next cipher frame protocol and communications scheme (256 max, expandable) for communications plan diversity (optional)
TDM Plan (1 B)—preplanned time domain multiplexing variants (optional)
TDMA Plan (1 B)—preplanned time domain multiple access variants (optional)
FDM Plan (1 B)—preplanned frequency domain multiplexing variants (optional)
FDMA Plan (1 B)—preplanned frequency domain multiple access variants (optional)
Unused (1 B)—one to file bytes for future protocol variants, one byte buffer
Protocol Header End (1 B)—end of protocol bytes, EOT or equivalent
Note: bit/byte expansion increases pre-planned variations (likely a look up table), e.g., one byte (1 B) has 2\hat{ }8=256 variations, 2.5 B 2\hat{ }12=4096, 2 B 2\hat{ }16=65,536 variations, etc.
Note: protocol bytes are in order of priority in case noise or timing interferes with signal
Note: Total 20 bytes (Optional Bytes are NUL), any needed growth added in future revisions
   Although a change in protocol through signaling is not necessary since the radios can be preprogrammed/preconfigured before deployment or changes sent via another message. However, this optional protocol scheme is included to expand functionality beyond fixed signaling for purpose of software defined networking, software defined communications, communications plan diversity, and additional security. The endpoint software would be designed to ingest and adjust to the new signaling scheme.

### Step-by-Step Process-Single Message Frame Signal Transmission

To accomplish the Cipher Communication, a step-by-step process for a single frame transmission is described. The process flow is listed below and shown in FIG. 2. As described later, this process may be concatenated for higher data throughput; multiplexed with other data signals and/or users; and/or distributed across the spectrum for mission assurance and resiliency.

### List of Step-by-Step Processes

Information Source
Message
File
Add Padding
Protocol (Optional)
Encryption
Add Error Correction Coding (ECC)
Frame
Number
Ping 1 Transmit (TX)
Calculation TX Start
Ping 1 Receive (RX)
Calculation RX Start
Calculation TX Stop
Ping 2 TX
Ping 2 RX
Calculation RX stop
Number
Frame
Process ECC
Decryption
Process Protocol
De-Padding
File
Message
Information Dissemination

### Further Description of Process Steps

START OF PROCESS—Following the process flow, box-by-box in FIG. 2.
INFORMATION SOURCE—As described earlier, information is generated by a user or system to form the message.
MESSAGE—The voice, video, data, or network frame to be transmitted is received or accumulated from the information source and stored as a file in memory.
FILE—A file from the message (voice, video, data, network frame) is created and stored as a file in memory. Key to cipher communications, after padding, encryption, and error correction coding, the modified message file will be treated as a very large number vice data. At the end of the process, the re-calculated number is re-represented as the original message.
ADD PADDING—The file is padded with nulls or other pre-planned, characters to fill out the standard payload bytes within the frame. An example payload size could be 1000 bytes (8000 bits, 1000 bytes, 1 KB). A 780 byte file (message bytes only) would be padded with another 120 null bytes (or equivalent) to create a file size of 1 KB.
PROTOCOL—A set of protocol bytes are created based on file type, size, and communications parameters; the bytes are appended to the file bytes (details below). Current protocol bytes total 20 bytes; however, are easily expandable if necessary. The total of the message and protocol are a new size file residing in memory.
ENCRYPTION—Using file-based encryption within memory, the padded file and appended protocol are encrypted using commercial or approved military grade encryption leaving a new, encrypted file (block of bytes) in memory. The same process is used to decrypt the file in memory. New encryption keys may be passed via this transmission method as ‘over-the-air rekey’ or distributed separately. Encryption/Decryption will occur via software, firmware, or specialty ASICs. Commercial examples of encryption include Data Encryption Standard (DES), Triple DES, Advanced Encryption Standard (AES), and Rivest-Shamir-Adleman (RSA) among others.
ERROR CORRECTION CODING (ECC)—ECC is used to reduce bit errors by extending the frame by a percentage matching the worst-case clock differential between two circuits or other environmental variables such as multi-path interference, changes in the medium environment (RF, Acoustic), or speed of the vehicle if time versus distance may have an effect on reception time (i.e., hypersonic vehicles or space vehicles). Unlike other ECC approaches, this ECC is accomplished by adding a known sequence of bits and bytes to the end of the encrypted file prior to transmission. The additional bytes add margin to absorb any errors within the lower value digits of the large number (least significant bits). The ECC byte in the protocol bytes is stored in processor in case future transmissions are partially corrupted due to interference. Processing the ECC is described later.
FRAME—The Cipher Communications Frame (CICF) ‘final message’ is the original message that has been padded, encrypted, and ECC bytes added to the back of the message. Sum of bytes in the frame include: encrypted (message+padding)+error correction coding. This frame is the final block of bytes in memory to be converted to a number and transmitted.
NUMBER—the frame in memory is re-represented, in software or digital processing, as a very large, continuous number in memory. This number is used to digitally count down (or other, future calculations) the time difference in pings transmitted and count up from zero at the receiver.
CALCULATION—in the simplest form, in the transmitter, the number is counted downward to zero with continuous comparison checks during the calculation. The receiver increments the number (counting upward) at the same rate as the countdown arriving at the same starting, large number decremented at transmitter. The embedded processor or digital circuit (i.e., FPGA) relies on the digital board clock speed, or multiple thereof, to count downward or upward at the exact same rate. The calculation is measured in floating point operations (FLOPs), the FLOP rate must be identical at both ends or within tolerance of the error correction coding, adjustable, or software manageable with ‘wait times’ if the processors are different. For process flow, the calculation at the transmitter is labeled Calculation Tx (Calc Tx) and at the receiver Calculation Rx (Calc Rx). Calculations are started and stopped with the pings or other triggers leaving the frame and encrypted message in memory without transmitting the actual bits.
PING TRANSMISSION—a modulated signal is sent via cipher shift keying (CISK) from the transmitter through the medium to start and stop the calculation at the receiver through the medium as RF energy, acoustic energy, optical light, or visual signal through air, space, water, cable, or fiber. The signal sent from the transmitter is labeled Ping Tx and signal arriving at the receiver Ping Rx. Ping Tx is sent at the same time the transmitter calculation starts and stops. When Ping Rx is received the receiver calculation starts and stops.
NUMBER TO FRAME RECONVERSION—the large number residing in memory from the calculation is re-represented as encrypted, encoded file for further processing.
PROCESS ECC—The end-processor removes the ECC as well as analyzes any errors in the bits and bytes to calculate signal transmission errors and/or clock and/or time adjustment for future messages. Example, a 1 KB (1000 bytes) encrypted message may get an additional 100 bytes of ECC added to the end to give a 10% margin in signal transmission to account for clock error, timing error, or other interference.

Error Correction Process. Bit errors near end of the ECC are used to adjust the circuit board clock timing accordingly (faster or slower). If the clock is slightly slow, the process will yield an undercount of bits the generated number in memory will be less than the original value sent by Cipher Communications Processor (Transmitter) 14T. If the clock is slightly fast, the processor will generate an overcount of bits and the number in memory will be higher than the value sent by Cipher Communications Processor (Transmitter) 14T.

Fast or slow clock errors will manifest within the least significant bytes and bits in memory and move up the chain of bytes in memory. The correction factor is calculated by dividing the total numerical value of erroneous bits (a small number) by the numerical value of the expected number of adds (approximately the large number) to yield the correction.

It may be difficult to identify the direction of the clock correction as faster or slower. To resolve the correction, the processor would calculate the value and apply it to the clock in one direction (example, slow the clock slightly). If the magnitude of the error increases, the processor will reverse the correction in the opposite direction (example, re-correct and increase the clock).

ECC Calculation Example. For the text example below, the 300 B sample text message with padding, protocol, and ECC added up to 352 B takes 15,837,159 additions in memory to achieve the message in the receiver. If the CPU clock speed is 1 billion floating point operations per second (1 GFLOP), the identical bytes can be regenerated in about 15.83 milliseconds. A 25 bit error divided by 15,837,159 (plus or minus 25) multiplied by the calculation time adds yields about a 25 nanosecond correction to the clock timing. If the correction is in the wrong direction, the next ECC calculation would double and the processor reverses the correction to the baseline and then adds the correction in the right direction (faster or slower).
DECRYPTION—the file is decrypted using the file-based encryption key from the transmission endpoint leaving the original message and protocol bytes.
PROTOCOL—using the protocol bytes, the original file is recreated including appending the file type (example *.pdf) in storage. If the message is longer than what fits in the original frame payload size then multiple frames are sent to complete the message. The message is then re-assembled in memory and then stored as a larger file. The multiplexing and multiple access schemes assist as to where the rest of the communications should have arrived in frequency or time domains. They are re-assembled similar to TCP/IP processes. The protocol bytes are removed leaving the original message in memory.
Protocol Note: The Time Stamp not only stamps the message transmission time but assists in maintaining processor time should the sender/receiver want to use TDM methods, combined with clock adjustments, to send the signal with only one ping vice two.
DE-PADDING—Reverse of the padding process in which the nulls rounding out the file are removed leaving the original message. A representative padding byte is included in the protocol bytes if needed.
FILE—the remaining file is cleaned up and labeled with the correct file type and time stamp. If the message is part of a larger file, it is stored, reassembled, and time stamped.
MESSAGE—the file is extracted for forwarding to the intended user or system.
INFORMATION DISSEMINATION—as described earlier, the information is forwarded disseminated at the far receiver for use by the user or system.
END OF PROCESS.

### Communications Options

### Acknowledgment Message (Optional)

If an acknowledgment of the message is required by the sender, the user use the same message scheme (example 1 KB message) with a simple acknowledgment encrypted inside or added to another outgoing message. For multi-frame messages, use TCP/IP protocols consolidated in an outgoing frame acknowledging certain frames or packets and requesting resend of others prior to message re-assembly. Alternatively, it could just be a pre-planned response ping if correctly received or nothing if not received.

### Clock Synchronization Message (Optional)

If clock maintenance across the sending and receiving stations is required, start and stop pings may sent through the spectrum with a known, pre-planned difference in time. Calculation of the difference allows the digital processor at the receiver to adjust their internal timing clocks to more closely align the digital circuit timing as necessary. Clock synchronization may occur before the primary message transmission or during other times to maintain proper clock rate within the limits of the electronics. Modern timing circuits may last hours, days, and weeks before needing an external clock synchronization. For example, a full frame of bits and bytes of ones could be sent, and offset calculated from where any zeros occurred.

### Single Ping Employment

Process for single ping communications—instead of starting the calculation on the first ping, a time domain multiplexing (TDM) plan is published. The calculation at both the transmitter and receiver starts at a pre-planned time. When the message calculation (countdown to zero) is reached, the transmitter sends the ping ending the calculation in the receiver.

### Large Files and Re-Assembly

Process for large file sizes. If the message is larger than the normal frame size, it is broken up into multiple messages, sent in multiple transmissions, and reassembled in memory on the receiver end using the frame numbers in the protocol.

### Multiple Messages Single Channel

Process for multiple messages or frames in a single channel. The sender can continuously send multiple messages or frames on a single frequency by concatenating the ping. Ping 1 is sent followed ping 2 ending the message calculation. Ping 2 is also the start of the next message followed by ping 3 ending the message calculation. Ping 3 is the start of the next message and so on. The receiver will allocate multiple calculation strings as necessary for continuous processing.

### Multiple Messages in Multiple Channels for Higher Data Rates

Process for sending multiple files or frames in parallel. The transmitter and receiver have multiple input channels spread across multiple frequencies and processing channels for multiple messages at once. The spread in frequencies can vary widely across the spectrum. The transmitter sends one ping to start multiple calculations at once and then sends ending pings on multiple frequencies using Frequency Division Multiplexing (FDM) when each message frame ends. The transmitter and receiver process the frames in multiple process threads on the same radio. Alternatively, the transmitter can send start pings on the different frequency channels independently processing the frames.

### Multiple User Multiplexing

Process for multiple users in the spectrum is similar to TDMA and FDMA today in timing user access (TDMA) or assigning separate user frequencies (FDMA). However, unlike TDMA and FDMA where users are grouped closely in time sequences and spectrum, communications planners may spread the users across much larger time sequences, wider frequency spectrum, or both. In addition, the protocol bits can change or update the multiplexing schemes, timing, and frequency assignments in near real time.

Process for multiple users sharing of frequencies and collision detection. In the early days of Ethernet, computer networks shared a coax cable (single channel transmission medium) using a medium access control method called carrier-sense multiple access with collision detection (CSMA/CD). When the computer or network device went to transmit, it listened on the line first and then began the transmission. If two signals collided in the coax medium, both transmitters stopped and backed off by a random amount of time and started the process over again. If the number of frequencies is limited for cipher communications, this process may be built into the transmitter/receiver radios. Listen first, if clear, start the transmission. A method to count and track the pings will be implemented.

### Further Discussion of First Preferred Embodiment

Referring back to the first preferred embodiment shown in FIGS. 1 and 2, the following describes preferred operations and components.

### Information Source

Information and messages are created outside of the cipher communications processor; however, are included in the architecture in FIG. 1. to reinforce that any set of bits and bytes forming a message may be relayed by this system. The message is inclusive of all types of transmitted communications including voice, video, data, and other (entire) network technology protocol frames relaying the messages in other communications and network architectures.

In FIG. 1, an information message is created by a user or automated system outside of the cipher communication system, but as part of the larger architecture, for an intended recipient, recipients, or other automated systems to act on. For example, a user may type a textual message such as a military message or create an information broadcast consisting of some number of bytes. An image may be created by a photographer, medical system (Xray), or a satellite earth observation system. Computer systems, equipment, electronics, chipsets, and software to create broadcast messages or automated systems are readily available on the market today.

Voice communications such as broadcast radio, telephone systems, cellular phones, or tactical radios relay voice or other audible signals for intended recipients or broadcast receivers. It is expected that any analog information (voice, music) would be digitized into a file. If the voice, music, or other audible signals is time/received sensitive, the communications, calculation, and relay rates would match the necessary specifications much like telephony and cellular systems today. Electronic systems, chipsets, and software that digitize voice, music, and other broadcast information are readily available on the market today.

Industrial equipment creates automated messages to relay their system status or send and receive operational commands; for example, an electric power generation system may send operating status messages or command an additional electric generator to come online to pick up additional electric load. Industrial Control Systems (ICS) often use a Supervisory Control and Data Acquisition (SCADA) protocol formats for controlling and monitoring industrial equipment. Modern ICS and SCADA equipment, electronics, chipsets, and software are readily available on the market today.

Another network technology protocol frame is specifically called out in case the system application calls for a relay of each frame without switching, routing, or other payload manipulation. For example, a SONET or Ethernet frame may be sent in its entirety and simply switched or routed without any additional network processing by the end points. Networking equipment, electronics, chipsets, and software are readily available today and may be programmed to present the frame to the Message Source System and CCP today.

The external Information Source system creating the message has the option to encrypt the files prior to placing it in the Message Source System. Each information system has its own industry file format; for example, *.jpg, *.doc, *.txt, *.mpeg, etc.

The Information Source in this architecture ‘made’ by assembling industry hardware and software components that generate information to be communicated. In the end the information message is generated, received, placed, and stored as a File on a Message Source System in its native format.

### Message Source System

Message source system 12 is a component in shown in FIG. 1 where the message resides as a file awaiting to be retrieved by Cipher Communications Processor (Transmitter) 14T or pushed onto the CCP. In the simplest case, it is a laptop, computer, or server with file storage and a file structure connected to Cipher Communications Processor (Transmitter) 14T through common network connection technologies such as ethernet, USB, serial connections, or similar. The source system has a file structure and related management software that allows Cipher Communications Processor (Transmitter) 14T to poll, detect, and retrieve message files that are ready for communication. Alternatively, software on the source system can be written to push the message file onto Cipher Communications Processor (Transmitter) 14T for follow on processing and transmission. An example of current, commercial software that can accomplish this task is File Transfer Protocol (FTP). Additional software exists in industry, or can be created on the source system, to push the file to the CCP or the CCP may be programmed to routinely poll the file folder for the message and retrieve it. An alternative to FTP is to mount the CCP as an external server and store (drop) the ready message on it. The message file naming convention will have a date/time stamp and prioritization so that the CCP knows what message file to send next.

One example of message source system 12 includes an enterprise server or a cloud-based server where large amounts of data is stored. At those server systems, ready message files can be dropped into the CCP processing folder and retrieved or pushed to the CCP for communication with the receiving end points. Another example is an imaging system on an earth observation satellite. A completed image resides on the image processor or satellite control processor ready for communication. At the appropriate time, for example when a satellite ground terminal is in view, a software routine on the satellite transfers the file to the onboard CCP and communicated through the transmitter, amplifier, and antenna using cipher processing techniques.

Message source system 12 in this is preferably fabricated by assembling industry hardware and software components that receive and hold the information to be communicated in its native or user encrypted format as a file. Software on the message source system sends the file to the CCP or the software on the CCP retrieves the file for follow-on processing and transmission.

### Cipher Communications Processor (CCP)

Cipher Communications Processor (Transmitter) 14T shown in FIG. 1 preferably consists of a circuit board with analog, digital, processing, and network components. Analog components include an oscillator and related circuitry for an intermediate frequency (IF) carrier and to modulate, via cipher shift keying, a pulse marker signal or ping onto the IF. RF amplifiers and filters will prepare the pulsed IF for radio processing in the next block in the architecture. Digital components include a digital signal processor (DSP) to generate or detect the pulse amplitude modulated (PAM) marker signal (ping). Alternatively, common communications circuitry may replace the DSP in IF and RF processing.

An embedded processor with a real-time operating system handles message files in storage and real-time memory. Cipher Communications Processor (Transmitter) 14T embedded processor can consist of one of, or a combination of, many types of available embedded processors to include digital signal processors, general purpose processors (GPPs), application-specific integrated circuits (ASICs), other types of Computer Processing Units (CPUs), or other digital processors such as a field-programmable gate array (FPGA). For purposes of this description, the term CPU encompasses all digital processors listed above, or any other calculating technology, that may perform the padding, protocol, encryption, ECC processing, and the numerical processing in the transmitter or receiver. The CPU conducts floating point operations (FLOPS) based on clock signal provided internally or from the accompanying circuit board. The clock speed will be adjustable, internally or externally, to account for bit error rate correction based on calculation of errors within the ECC.

Real-time software within the CCP embedded processor detects a new message either in the message source system or its own file structure. If the file is too large for the cipher frame, the file is broken up into multiple, numbered files; communicated separately; and re-assembled on the receiving end. The software writes the file to be communicated in active memory and prepares it for the communications calculation. The embedded processor software performs file padding, protocol processing, encryption, error correction coding processing, and frame management in real-time memory. The embedded processor software then represents the completed frame as a number across the concatenated bits and bytes in memory in preparation for ciphering (arithmetic calculations).

Through real-time software, transmitting CCP initiates the first ping through a DSP or communications circuit generated pulse and begins mathematically calculating by decrementing bits in processor memory and comparing the entire frame with a zero value. When the frame bits are all zero, the second ping is sent. The receiving CCP DSP or communications circuitry detects the rise and threshold of the received ping and the processor begins calculating (ciphering) starting from a number value of zero. The embedded processor increments the value by a value of one (1) in processor memory until the second ping is received. The real-time embedded software in the receiving CCP completes the remaining processing (ECC, decryption, protocol, de-padding) and makes the file available to the message source system in its native format.

### Radio System

In FIG. 1, the radios, amplifiers, and antennas make up radio system 20. Radio system 20 is specific to the frequency (VHF, etc.) or band (S, Ka, etc.) implemented; however, the assembled components are the same and typically off-the-shelf. Modern, digital radios take in a series of bits, modulate them on an IF carrier based on the planned modulation scheme, and then upconvert the modulated IF to the RF carrier. The signal passes through an amplifier chain and is transmitted through the appropriately sized and configured antenna for the application. In this architecture, instead of receiving a series of bits directly or through modulated IF carrier, the CCP interfaces with the radio through an IF carrier modulated with a single pulse amplitude modulated marker signals or pings. The IF carrier pings are upconverted and transmitted through the same amplifier chain and appropriate antenna. Notably, when a ping is not being transmitted, the RF carrier is not constantly or on-the-air. The spectrum is silent at that RF or medium frequency unless a ping is present.

Some digital radios do not operate from external IF signaling but modulate the signal onto its own internal IF. In this case the radio may receive a single trigger pulse as an amplitude modulated marker signal. If the radio interface operates from bits and bytes, the transmitting CCP will be programmed to send a single bit or appropriately coded byte to instruct the radio to initiate the RF ping. The receiving CCP will be programmed to receive the same.

Some radios, such as software defined radios (SDRs) often contain digital signal processors (DSPs) that do not use IF but directly transmit or receive at the RF carrier frequency level. These radios have digital interfaces and the transmitting CCP will be programmed to send a single bit or appropriately coded byte to instruct the radio to initiate the RF ping. The receiving CCP will be programmed to receive the same.

If the cipher shift key modulation scheme of a single pulse amplitude modulated ping is replaced by a different signal and modulation such as a short burst of bits or a single byte with the cipher shift embedded, the CPP sends the few bits or byte to the radio to transmit the bits or byte using the planned modulation scheme such as FM, BPSK, QAM, etc. The radio is only on-the-air long enough to transmit the signal and then the spectrum is silent again. As an example, the CISK scheme may be four bits such as 0001 where the modulated shift from 0 to 1 is the exact timing marker that signals start and stop of the cipher calculation. In this case, a DSP sends all four bits in coordination with the timing of the embedded processors on both ends.

In optical cipher communications system, the CCP would pass the marker signal ping as a voltage without the IF and optical transmission system would directly modulate the ping onto the optical carrier either at the laser transmitter or a separate optical modulator. The laser light would may be amplified and sent out via free space optics or through fiber cable.

In an acoustic cipher communications system, the CCP would pass the marker signal as a voltage that is electrically coupled to a sonar transducer. Depending on the sonar design, the marker signal could also be passed via IF and upconverted or down converted as appropriate and then transmitted via sonar transducer at the intended acoustic frequency. The sonar transducer may be within a submarine or shipboard (fixed or towed) sonar system or could be part of a sonobuoy dropped from an airplane. The sonar ‘pings’ would then be transmitted through the water to the intended message recipients.

In an audio cipher communications system, the CCP would pass the marker signal as a voltage to be electrically be coupled to an amplifier chain and speaker. Depending on the audio system design, the marker signal could also be passed via IF and upconverted or down converted as appropriate and then transmitted via amplified speaker and received via a microphone and amplifier chain intended audio frequency, possibly outside of the range of human hearing.

In visual cipher communications system, the CCP would primarily be a block of software on a laptop, tablet, or cell phone. The device would have a requirement of the ability to prevent CPU interrupts during the signaling operation and manage/match clock rate so calculations on either end will be identical. The operators would load the message, start the CCP software processing as they send the first the visual signal and the send the second visual signal when the CCP signals the operator the calculation is complete. Additional error correction coding would be added to account for variable in human response time in visual signaling via semaphore flags, flag hoist, or flashing light.

### Example of a Text Message Being Transmitted Utilizing a Preferred Embodiment of the Present Invention

To demonstrate a message flowing cipher communications system 10 (FIG. 1), a 300 byte (B) text message consisting of 8-bit ASCII characters (ASCII-8) is used an example of a detailed step-by-step functional process for a single transmission outlined in FIG. 2. An ASCII-8 text message is analogous to a military message, commercial teletype message, or a teletype-like information broadcast such as weather or news. This communication method has historically has been used in the HF spectrum or legacy cable system.

Obviously, the length of any message may be much longer; however, it was limited to a maximum of 300 B to simplify the example. The top set of blocks (FIG. 2) represent the transmitter (TX) side of the cipher communications system and will be discussed in the next paragraphs and figures. The bottom line of blocks represents the steps in the receiver (RX) and will be discussed later in the paragraphs and figures. For this example, High Frequency (HF) radio band (3-32 MHz) will be used with a planned HF frequency of 10 MHz and an Intermediate Frequency (IF) will be 455 kHz. The processor will operate at 1 billion (giga) floating point operations (FLOPS) per second or 1 GFLOPs. The embedded processor will multi-threaded and can simultaneously perform more than on operations per FLOP. For example, the CCP TX embedded processor will simultaneously decrement the large number and compare that number to zero.

The following paragraphs in this example directly follow the block diagram shown in FIG. 2 with any clarifying discussion of operating at this HF frequency and processor speed.

### Information Source

In the Information block in FIG. 2, information is generated by user typing information into a test message in ASCII-8 text. In this example, the information is a cipher test message consisting of the pangram “THE QUICK BROWN FOX JUMPS OVER THE LAZY DOG” and other strings of ASCII-8 text characters routinely used to test text messaging systems.

### Message

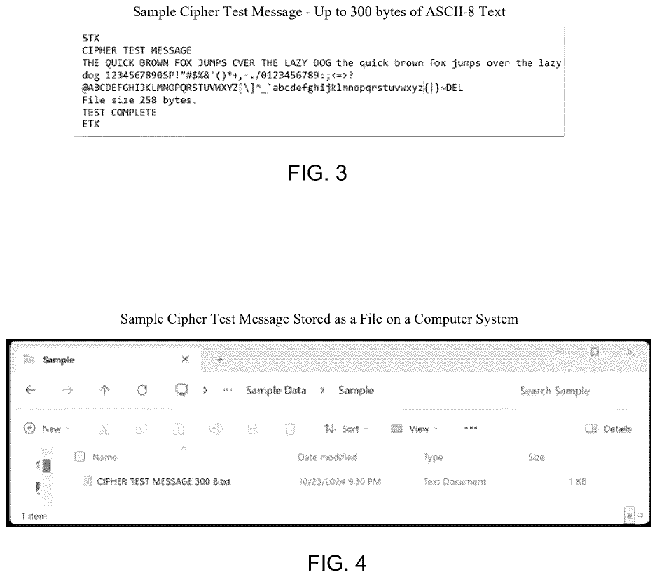

When the user is done typing, the accumulated information is now a complete message to be transmitted. FIG. 3 is the example of the 300 B, ASCII-8, test message. The actual number of characters is 258 to demonstrate padding up to 300 bytes.

### File

In the File block in FIG. 2, the message is stored as a file on the computer used to generate the message so that it may be moved between different elements of the system. FIG. 4 is an example of the Cipher Test Message stored within the file structure of a computer.

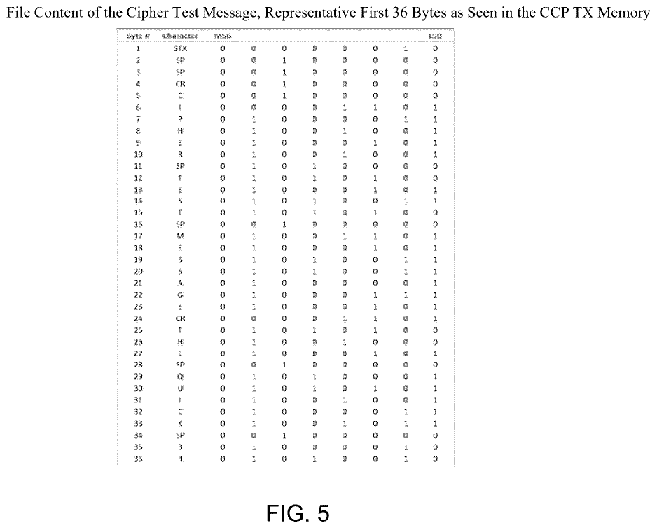

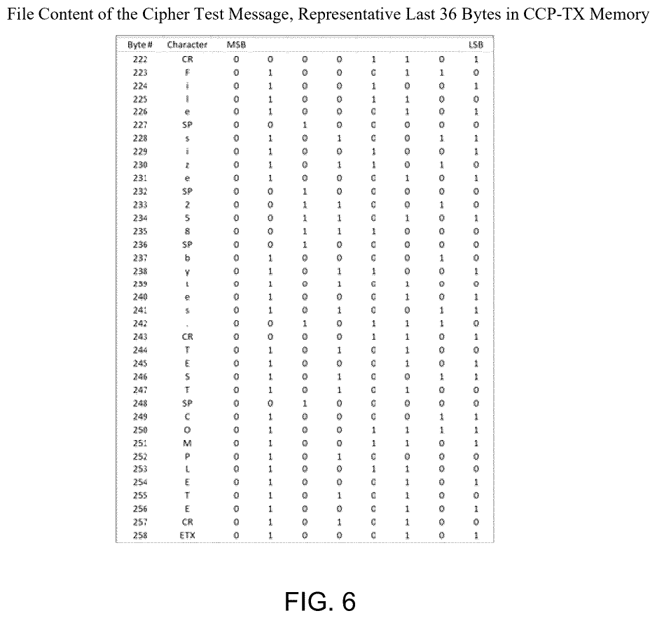

In FIG. 1, the File is transferred to the Cipher Communications Processor (Transmitter) 14T for the remainder of the transmission. As seen in Cipher Communications Processor (Transmitter) 14T memory, the contents of the file are shown in FIG. 5. The first column is the count of bytes within memory for illustrative purposes. The second column displays the ASCII-8 Characters residing in memory. The next columns represent the appropriate bytes as seen in memory with the most significant bit (MSB) on the left and least significant bit on the right. In the example, each byte is displayed in a column to illustrate each process step. In reality, the bytes may be side-by side depending on the physical structure of the memory chipset. As seen in FIG. 3, the message bytes start with ASCII-8 character STX (start of text) followed by two SP character bytes (spaces) followed by a character byte CR (carriage return), and message text character bytes “C”, “I”, “P”, “H”, “E”, “R”, and so on. FIG. 5 displays the first representative bytes of the message within the binary file. FIG. 6 displays the last representative bytes of the message within the binary file ending with ETX (end of text).

### Padding

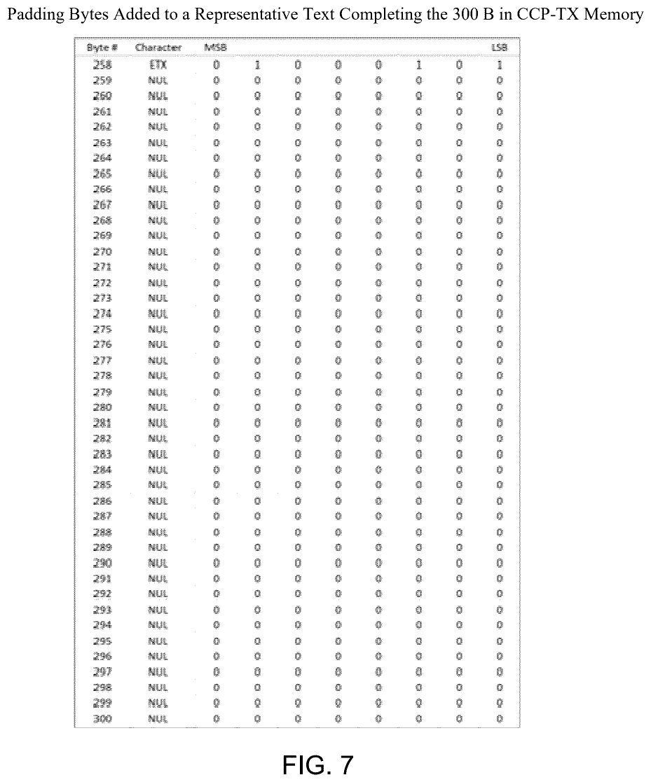

In the example being described, it should be noted that the user did not utilize all 300 B of the available maximum size of the message format. The remaining message is padded with additional bytes to round out the message. In this case, the ASCII-8 NUL character (bits of all zeros) to complete the message. A NUL is used here for simplicity; however, any string of repetitive bytes may be used. The NULs will be removed by the receiving Cipher Communications Processor (Receiver) 14R. FIG. 7 is an example of padding the remaining message with padding bytes to be discarded. A sample padding byte will be included in the protocol bytes later as a reference if needed by the processor.

### Protocol

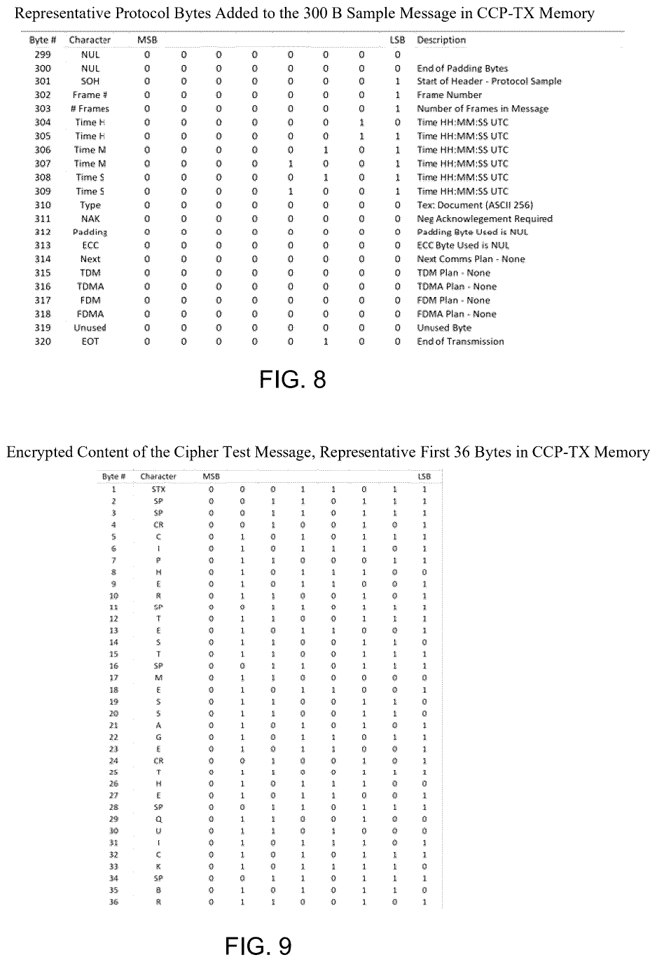

A sample protocol is detailed in the “Protocol Message Concept Bytes” described elsewhere in the detailed description. To aid in processing and to direct changes in the communications plan, a series of protocol bytes are added after the original message and any padding bytes. In this example, 20 protocol bytes are added starting with SOH (start of header) and ending with EOT (end of transmission). If a larger message was broken into multiple frames, then the frame number and number of frames is included. A time stamp, acknowledgement requirements, and multiplexing plans are also included. FIG. 8 is an example of the protocol bytes added after the message and padding bytes. The additional 20 B raise the number of bytes in memory from 300 to 320 B. A short description of the protocol is included in the far right column.

### Encryption

The message, added padding, and protocol bytes are encrypted to prevent unintended users from reading the message. Any method of encryption may be used; however, in this case a file-based encryption within the memory is used to encrypt the block of bytes. The users of the system all have the same encryption key. FIG. 9 is an example of message bytes encrypted in memory with a simple algorithm. Note that the encrypted bytes no longer match those in FIG. 5.

### Error Correction Coding (ECC)

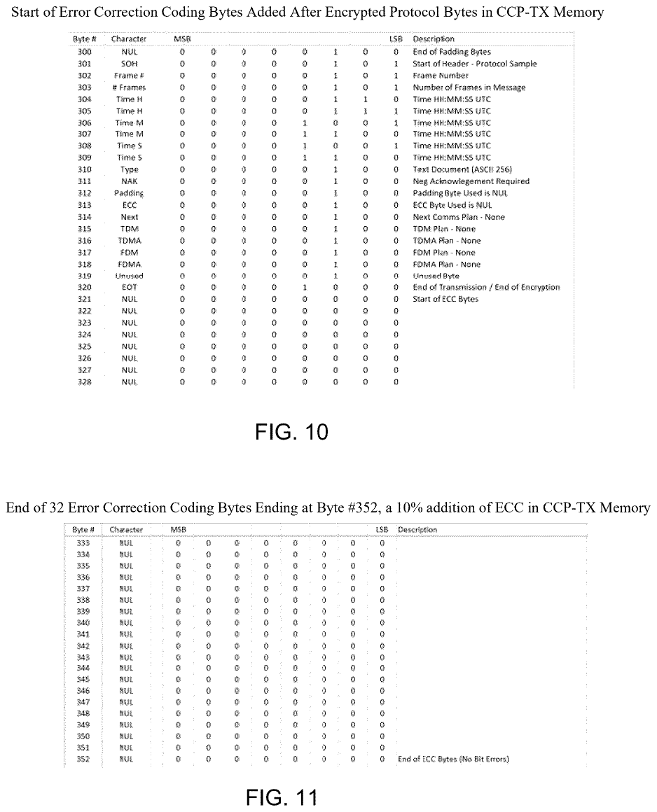

In this example, a 10% ECC is added to the current total number of bytes (message, padding, and protocol) to guard against or absorb bit errors. In this example a NUL character (all zero bits) is used to illustrate the addition of ECC raising the number of bytes from 320 to 352 B. FIG. 10 is an example of the ECC bytes added immediately after the encrypted protocol bytes. FIG. 11 is an example of the frame with the ECC bytes totaling 352.

### Frame

The 352 bytes consisting of the original message bytes (encrypted), additional padding (encrypted), protocol bytes (encrypted), and the 10% ECC bytes represent the complete Cipher Communications Frame. This frame is the final block of bytes in memory to be converted to a number and transmitted.

### Number

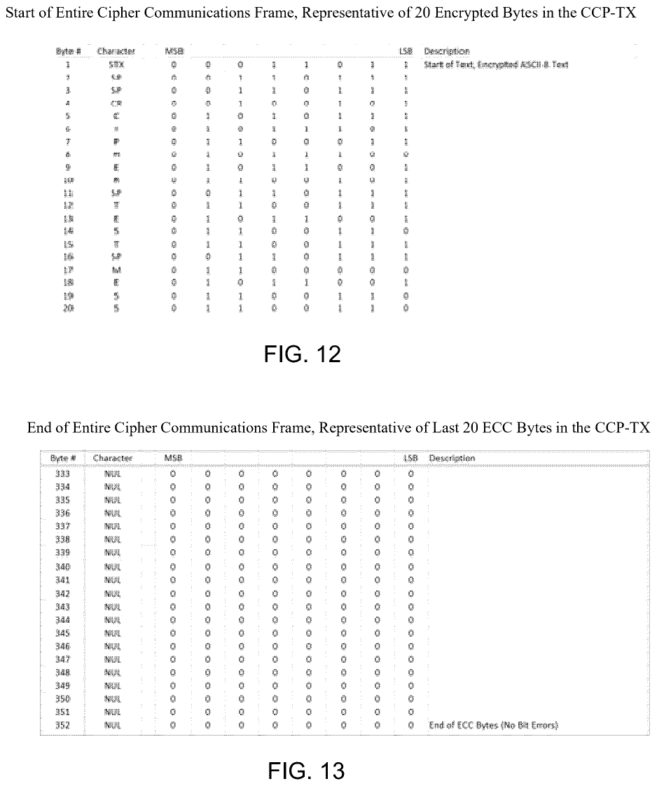

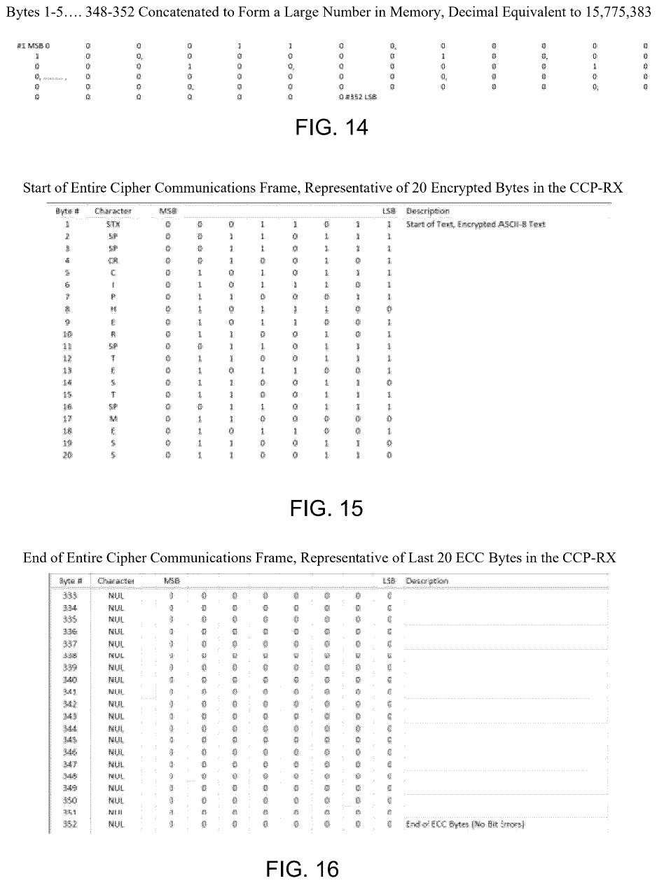

The Cipher Communications Processor now treats the frame of 352 bytes (2816 bits) as a very large number instead of data. The sequential bytes from 1-352 are concatenated digitally represent the large number consisting of 2816 bits. In FIG. 12, the left-most bit within the first byte (#1) is the most significant bit in the most significant byte. In FIG. 13, the right-most bit in the last byte (#352) is the least significant bit in the least significant byte. The most significant bit (in #1) to the least significant bit (in #352) represent the total large number. The decimal equivalent of this number is 15,775,383. This number will be arithmetically decremented in Cipher Communications Processor (Transmitter) 14T (count down) and will be the target number counting up from zero. FIG. 14 illustrates the concatenation of the bytes in memory to form the large number across bytes 1-352.

### Ping 1 TX

At the start of the cipher calculation within Cipher Communications Processor (Transmitter) 14T, a single ping is transmitted through the HF spectrum to signal the Cipher Communications Processor (Receiver) 14R to begin its calculation. In an RF example, the ping is amplitude modulated onto an IF (455 kHz), sent to the radio system and upconverted onto the HF 10 MHz carrier frequency. Unlike other communications systems, the carrier is not online continuously. It is on just long enough to transmit the ping through the spectrum to the receiving radio.

### Calculation TX Start

As Ping 1 is transmitted, Cipher Communications Processor (Transmitter) 14T processor begins decrementing the large number one bit at a time (subtracting 1 or 0000 0001) with each computer processing unit (CPU) clock cycle. After each subtraction, the large number is compared with zero. In this example, we assume the CPU can process multiple threads simultaneously thus each calculation and comparison can be done in one clock cycle. However, if the CPU is single threaded, one CPU clock cycle is the subtraction and a second CPU clock cycle is the comparison to zero, then Cipher Communications Processor (Receiver) 14R would be programmed with the additional wait time clock cycle(s) during its incrementing calculation.

### Calculation TX Stop

When Cipher Communications Processor (Transmitter) 14T count down reaches zero it stops calculating and initiates a second ping to tell the receiver to stop its calculation.

### Ping 2 TX

At the end of the cipher calculation in Cipher Communications Processor (Transmitter) 14T, a second, single ping is transmitted through the HF spectrum to signal Cipher Communications Processor (Receiver) 14R to end its calculation.

### Ping 1 RX

The first ping, Ping 1 TX transits the HF spectrum and arrives at the receiver. The ping is down converted in the radio to the IF and passed to Cipher Communications Processor (Receiver) 14R.

### Calculation RX Start

When the first ping arrives at Cipher Communications Processor (Receiver) 14R, it starts the calculation of the large number by incrementing the count upwards from zero with each CPU clock cycle. The large number representing the message grows in memory. If the transmitting Cipher Communications Processor (Transmitter) 14T CPU is not a single thread processor, additional wait cycles will be added to the software calculating the number to match Cipher Communications Processor (Transmitter) 14T calculation rate.

### Ping 2 RX

The second ping, Ping 2 TX transits the HF spectrum and arrives at the receiver. The ping is down converted in the radio to the IF and passed to Cipher Communications Processor (Receiver) 14R.

### Calculation RX Stop

When the second ping arrives at Cipher Communications Processor (Receiver) 14R, it stops the calculation of the large number.

### Number

Cipher Communications Processor (Receiver) 14R now has a large number consisting of 352 bytes (2816 bits) residing in memory. The digitally concatenated bytes from 1-352 represent the large number consisting of 2816 bits. The left-most bit within the first byte (#1) is the most significant bit in the most significant byte. The right-most bit in the last byte (#352) is the least significant bit in the least significant byte. The most significant bit (in #1) to the least significant bit (in #352) represent the total large number. The decimal equivalent of this large number is 15,775,383. The calculated number is identical to the number that started the calculation in Cipher Communications Processor (Transmitter) 14T unless there are bit errors introduced by very small differences in CPU clock speed or other environmental factors. They will be addressed by the ECC.

### Frame

Cipher Communications Processor (Receiver) 14R now treats the large number in memory as cipher communications frame consisting of the message, padding, protocol, encryption, and ECC bytes. The bits and bytes are aligned in Cipher Communications Processor (Receiver) 14R memory identically to those in Cipher Communications Processor (Transmitter) 14T. FIGS. 15 and 16 demonstrate the characters and representative bytes in Cipher Communications Processor (Receiver) 14R memory.

### Process ECC

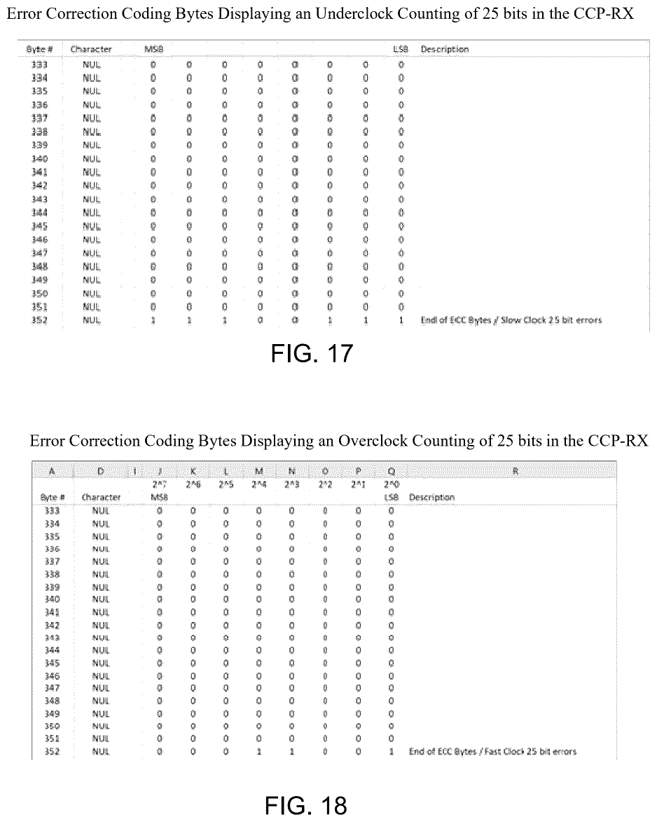

At the transmit site, Cipher Communications Processor (Transmitter) 14T added 10% additional error correction coding (ECC) bytes to guard against bit errors and aid in clock timing correction. FIG. 17 demonstrates a Cipher Communications Processor (Receiver) 14R that has a slightly slow clock causing a 25-bit error at the bottom of the ECC since it did not clock the last few additions through the number in memory. In byte #352, the character is intended to be a NUL byte, decimal 0, all zero bits; however, the errored bits represent the decimal number 231 which is 25 clock cycle additions short of rolling over the numerical byte in memory to all decimal 0 or NUL. At this step in the process, Cipher Communications Processor (Receiver) 14R detects the errored bit in the ECC bits and calculates the correction to the clock speed. The percentage of error is calculated over the large number and the time it takes to calculate it based on clock speed. The percentage of clock error clock is adjusted within Cipher Communications Processor (Receiver) 14R circuitry to minimized bit errors in the next transmission. For example, of Cipher Communications Processor (Receiver) 14R processor operates at 1 GFLOP but is operating slightly slow then the timing correction would increase the clock rate of 25 nanoseconds.

FIG. 18 demonstrates a Cipher Communications Processor (Receiver) 14R that is slightly fast clock causing a 25-bit error at the bottom of the ECC since it clocked a few additions to the number in memory. Bye #352 is supposed to be a NUL or decimally 0; however, the additional clock cycles increased it to decimal 25 or the byte representation in #352. To correct the timing error, a clock correction would decrease Cipher Communications Processor (Receiver) 14R by 25 nanoseconds. Within Cipher Communications Processor (Transmitter) 14T memory, the additional ECC bytes are discarded after processing. FIG. 19 displays the last 25 bytes but with the ECC bytes discarded in memory.

### Decryption

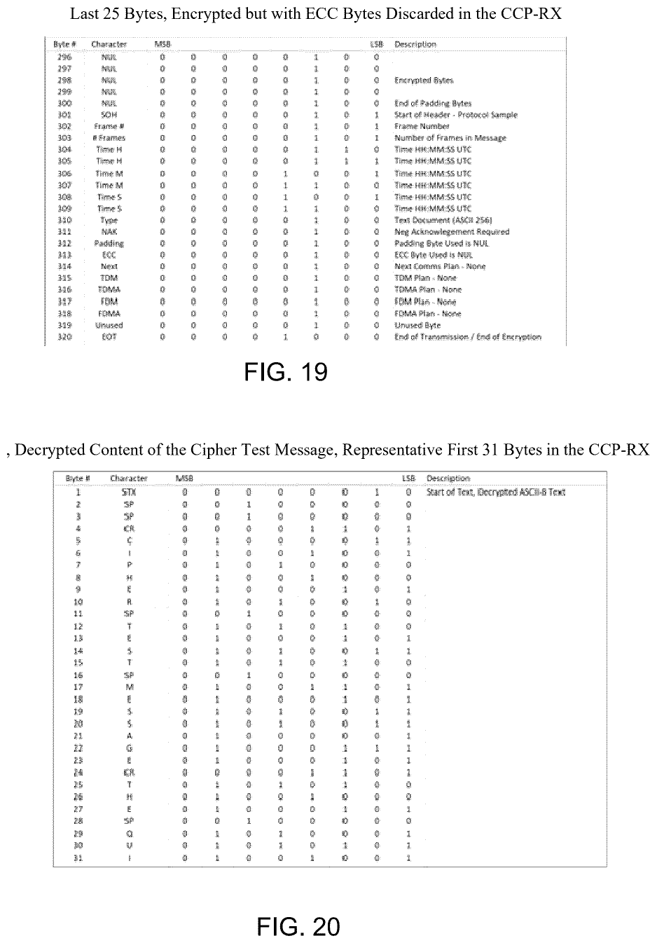

The message, added padding, and protocol bytes are decrypted using the same encryption key from Cipher Communications Processor (Receiver) 14R to allow intended users to read or process the message. Any method of decryption may be used; however, in this case a file-based decryption within the memory is used to decrypt the block of bytes. FIGS. 20-21 are examples of the decrypted message bytes, padding, and protocol bytes. Note that the decrypted bytes match those in FIGS. 5-8.

### Process Protocol

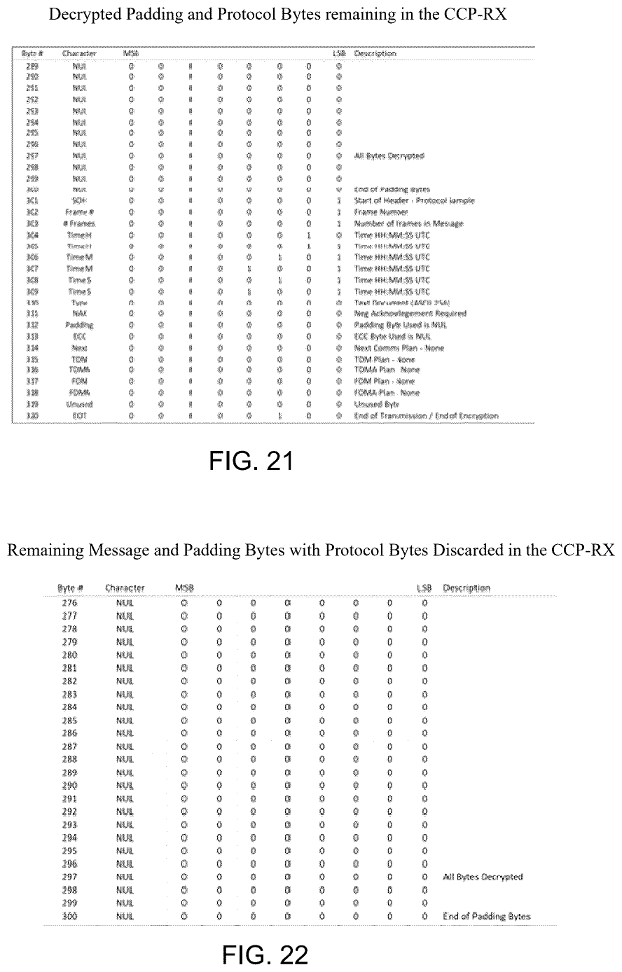

FIG. 21 displays the decrypted protocol bytes in Cipher Communications Processor (Receiver) 14R memory. The protocol is processed as necessary per the prior description of the protocol bytes. For example, the time stamp in the format of HH:MM:SS in UTC will be used as the message time stamp. If the file was larger than 300 B, the number of frames will be used to concatenate the frames according to the frame number elsewhere in Cipher Communications Processor (Receiver) 14R. The padding byte will be used to verify and remove the padding bytes in next step in the process. When the protocol bytes are processes, they are discarded in memory leaving the original message and any padding bytes. FIG. 22 displays the remaining message and padding bytes with the protocol bytes discarded in Cipher Communications Processor (Receiver) 14R memory.

### De-Padding

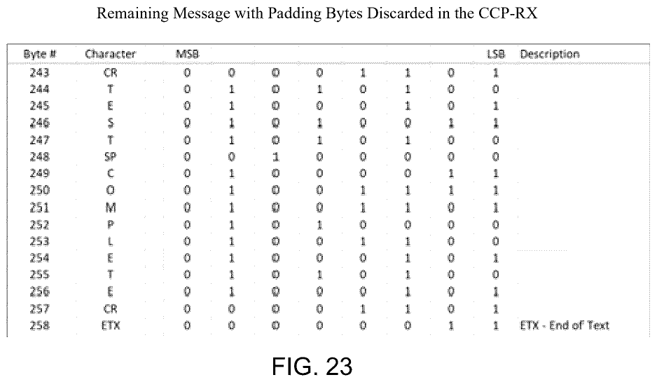

Note the user did not utilize all 300 B of the available, maximum size of the message format and the remaining message was padded with additional bytes to round out the message in Cipher Communications Processor (Transmitter) 14T. As indicated in the protocol bytes, the padding was the ASCII-8 NUL character (bits of all zeros) to round out the message. Cipher Communications Processor (Receiver) 14R processor finds and removes the excess padding bytes starting at the end of the 300 bytes and working backwards discarding the padding bytes (de-padding) until the end of the actual message (ETX) is found. FIG. 23 is an example of the end of the remaining message with padding bytes discarded.

### File

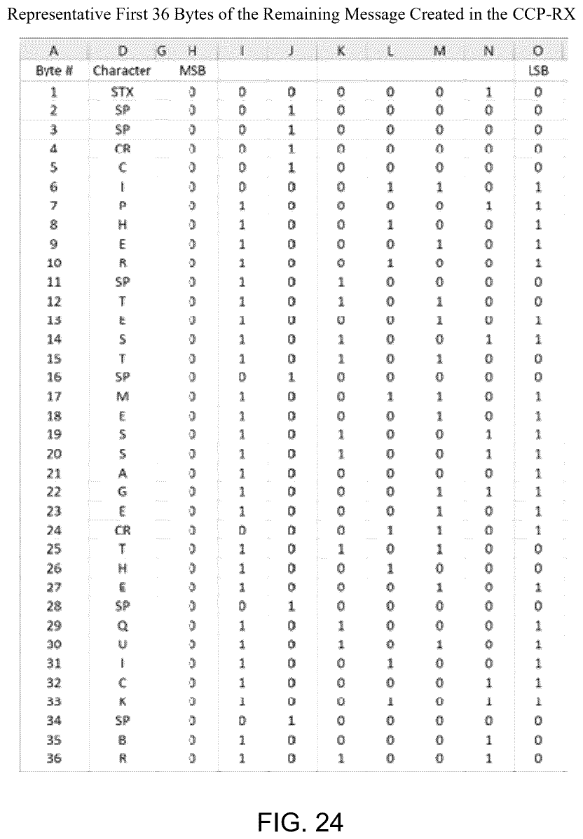

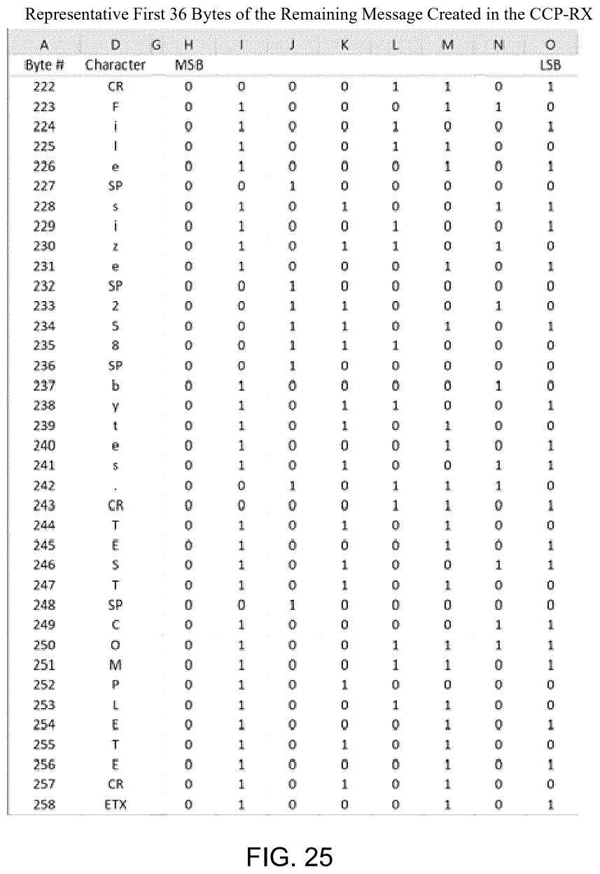

The remaining message is the text file that was sent from Cipher Communications Processor (Transmitter) 14T to Cipher Communications Processor (Receiver) 14R. FIGS. 24-25 display the remaining message text bytes in Cipher Communications Processor (Receiver) 14R memory. The protocol byte “Type” is used to label the file as a text file (*.txt) in Cipher Communications Processor (Receiver) 14R memory for further transfer to follow-on message processing.

### Message

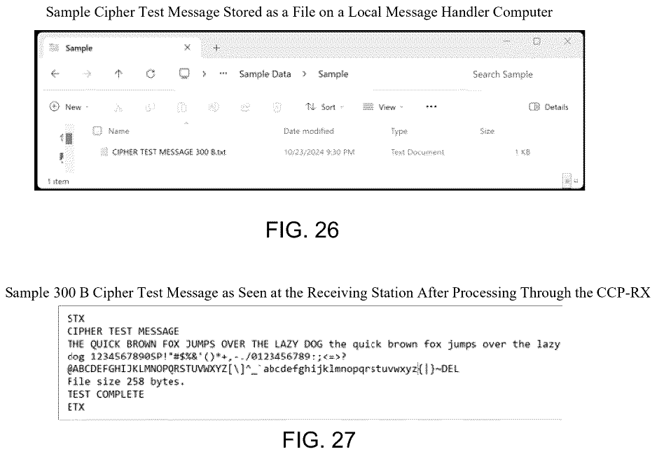

Cipher Communications Processor (Receiver) 14R transfers the *.txt file to the next device in the chain similar to the message source system 12 in FIG. 1. The file is stored locally on a message handler computer. FIG. 26 is an example of the newly created file “CIPHER TEST MESSAGE 300 B.txt” stored in a local computer acting as a message handler. FIG. 27 displays the actual 300 B ASCII-8 Cipher Test Message as seen at the receiving station after processing by Cipher Communications Processor (Receiver) 14R. It is identical to the message sent by the transmitting station.

### Information Dissemination

The message displayed in FIG. 27 is then forwarded, or disseminated from the local message handler computer through the receiving station's computer or enterprise equipment.

### Preferred Applications of the Present Invention

Multiple scenarios of use and preferred embodiments in the surface maritime, subsea, terrestrial, airborne, spaces domains using RF, optical, or acoustic transmissions are described below.

### RF—Surface Maritime Scenario

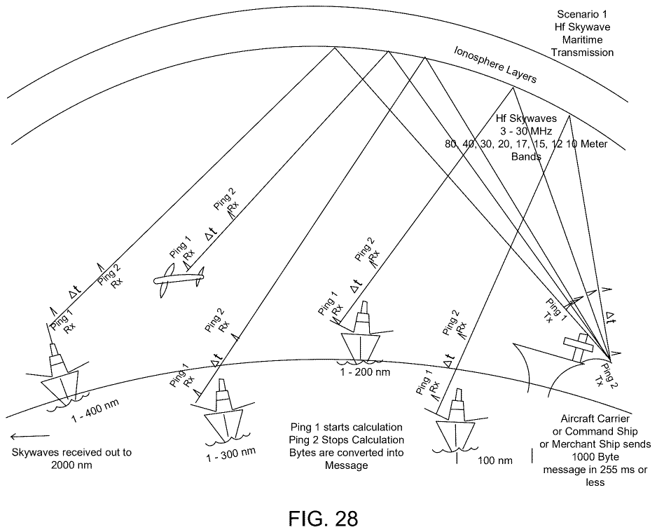

In FIG. 28, a command ship such as an aircraft carrier sends ciphered communications signals in the HF spectrum using HF sky waves (reflecting off ionosphere layers) to reach assigned units 100's of nautical miles away. The ships, aircraft, and (surfaced) submarines receive the pings and calculate the message in their receivers. Based on the tactical environment the units may or may not acknowledge the message. The dispersed units can also send their messages in the same fashion. The pings leave the spectrum empty of RF energy for most (>99%) of the time.

For line-of-site communications, the ships, aircraft, and submarines (surface or periscope depth) and use the same technique across the HF, VHF, UHF, or higher bands of the spectrum. Additionally, an aircraft can relay the signal, extending line-of-site beyond the immediate horizon.

### RF—Terrestrial Scenario

Mobile radios and fixed stations, including towers, may pass messages via line-of-site, cipher communications. Higher towers can extend the distance with greater visibility of the horizon. Additionally, an aircraft can relay the signaling the extending line-of-site beyond the immediate horizon. A military tactical team on the ground would be less vulnerable to geo-location and intercept due to the short and random transmission time in the spectrum. This can be further enhanced by spreading the transmissions broadly across multiple frequencies. For example, the first ping may be in the higher HF and the second ping in the higher VHF based on a pre-planned FDM communications plan. If multiple radios are sharing limited spectrum, CSMA/CD may be implemented to avoid multiple pings from interfering with a single communication.

Similar to microwave towers and systems today, focused microwave cipher communications systems can relay message traffic using much less (99%) energy in the spectrum by repeatedly sending cipher communications frames instead continuously transmitting the bit stream. A common microwave frame may be sent via ciphered calculation instead transmitting the frame bits through the spectrum. Using the process for Multiple Messages Single Channel, the transmission system can simply concatenate the pings for continuous calculation of messages in multiple processing threads.

Traffic throughput can be increased by using multiple frequencies and multiple transmitters passing concatenated pings in a FDM fashion.

### RF—Airborne Scenario

Unless they are using SATCOM, multiple aircraft can communicate using line-of-site transmission, typically in the VHF or UHF frequency bands. VHF is typically commercial traffic and UHF military traffic. Distance may be 100 nm or more given the aircraft(s) altitudes. Instead of continually sending voice or data as a stream of bits, an equivalent cipher communication can free up the spectrum (by up to 99%) and only send the pings for real-time calculation of the data. For example, voice traffic will still be heard in real-time with short delays due to calculation time which likely would not be noticeable.

Military aircraft using cipher communications would be less vulnerable to intercept and geolocation due to the short and random, on-air time (ping). This can be further enhanced by using the single ping method in a pre-planned TDM communications plan. Military aircraft may also spread the pings across different frequencies in an FDM communications plan.

If multiple radios are sharing limited spectrum (commercial or military), CSMA/CD may be implemented to avoid multiple pings from interfering with a single communication.

### Acoustic—Subsea Communications Scenario

Cipher communications may be used underwater, within temperature layers naturally forming communications boundary layers. When an acoustic ping is transmitted from one submarine to another, the first ping within the boundary layer starts the calculation and the second ping ends the calculation to produce the message. This has significant advantages over current subsea communications that are affected by signal spreading, reflections withing the boundary layer (multi-path), and changes in the boundary layers. The timing of the communication pings can be managed to minimize these effects on the signal.

In addition to submarine-to-submarine communications. An equipped surface ship may communicate with the submarine with by transmitting sonar pings if it can breach the layers or if the submarine listens or transmits in the upper, subsea layer. A Maritime Patrol aircraft can drop sonar buoys that deploy sonar transducers to the lower layers to listen for submarines or transmit sonar pings. These same pings may be used for cipher communications with the sonar buoy equipped with the additional processing for transmitting and receiving the calculated messages.

The operational example is Nuclear Command Control Communications (NC3) where a ballistic missile submarine is commanded to launch its nuclear weapons using a short Emergency Action Message (EAM). Although Very Low Frequency (VLF) (3-30 kHz) and Extremely Low Frequency (ELF) (30-300 Hz) systems can penetrate seawater to various depths to communicate with submarines, an acoustic based cipher communications adds another method to ensure message receipt. In addition, using Multiple Messages Single Channel, much higher data rates may be achieved for greater communications capabilities.

### Optical—Maritime/air Scenario

Military ships and aircraft have historically transmitted messages in morse code over short, line-of-site distances using flashing light in the visible and infrared wavelengths. Cipher communications can replace the continuously transmitted messages, increase the data rate significantly, and even extend the range with increased light power (brighter flashes).

### Optical—Free Space Optics Scenario

Free Space Optics (FSO) systems have been used as fixed transmission sites, similar to microwave towers, and in mobile-tactical systems to communicate within line-of-site without using RF energy. These systems communicate with a steady stream of bits over an optical carrier, often using SONET, SDH, Gigabit Ethernet network protocols. Similar to the microwave tower above, FSO systems can use cipher communications to send the pings as flashes of light reducing the amount of power used to transmit and reducing vulnerability to detection and intercept despite focused pointing between the transmitter and receiver.

Cipher communications can extend the communications utility further by using non-directional transmission towers. Using higher optical power, the flashes can be transmitted in an omni-directional fashion with the receivers pointed at the towers to receive the broadcast, similar to RF broadcast television stations today.

### Optical—Cable Scenario

As mentioned above, optical cable networks continuously transmit bits, bytes, and frames using lasers and a variety of protocols such as SONET, SDH, or Gbe. Over long distances, for example terrestrial long haul or subsea cable networks, they use a series of optical amplifiers to extend and reshape the signal and receive it at the far end up to 100s of kilometers away.

Cipher communications can reduce the power consumption and extend the distances between amplifiers by passing dispersed ping instead of a constant bit stream. In one scenario, entire SONET frames may be calculated and transmitted via pings and recalculated at the far end. Using the multiple message technique, the pings can be concatenated and recalculated using multiple processing threads. The arriving SONET frames are received by the follow-on switch and transmitted to the next system in the network. The cipher pings are amplitude modulated signals. If the AM signals are shaped in the form of solitons, a more efficient wave, they will go further in the optical chain without amplification.

Modern optical cables use dense wavelength division multiplexing (DWDM), the corollary to RF FDM. Cipher communications may also be transmitted via DWDM to increase communications capacity but with less power and longer distances between amplifiers.

### Space—Geo Satcom Scenario

Historically, geostationary (GEO) satellites, sitting above the earth's equator at about 35,786 km, (also referred to as geosynchronous orbit) relayed communications (SATCOM) signals as a steady stream of bits of voice, video, or data via transponders. Transponders receive an RF uplink signal on one frequency and relay it on the downlink on another frequency. More modern GEO SATCOM processes the user communications using onboard digital signal processing (DSP) to include processing the signal in and out of a collective RF signal stream.

Cipher communications lends itself well to transponder GEOSATCOM communications in which the time-sensitive pings are relayed from the uplink frequency to the downlink frequency without delay, usually by an intermediate frequency (IF). By sending only pings spaced in time, the power consumption will be reduced since the transmission is 99% less RF energy. This power reduction significantly reduces the drain on the space vehicle batteries, especially in periods of eclipse when GEO vehicles struggle to recharge their batteries with solar power. Existing transponders operate across an RF band such as C, Ku, Ka, or Mil-KA. Cipher communications will also allow FDMA across these same bands but with much greater efficiency.

As demonstrated in recent conflicts (Russia/Ukraine), GEOSATCOM may be vulnerable to interference and jamming. Recently, there are concerns over unintended interference from terrestrial 5G, 5G non-terrestrial network (5G NTN) communications (ground and space based), and RF-painting of GEO satellites by LEO-based SATCOM. Cipher communications with higher amplitude pings should surpass the intended and unintended interference by naturally focusing the transponder and associated amplifier energy on the ping and differentiating itself from the noise.

### Space—Leo Satcom Scenario

In recent years, 1000's of SATCOM vehicles have been launched into low earth orbit (LEO) nominally between 500 km and 2000 km in altitude above the earth. Commercially they provide lower latency internet traffic than GEO SATCOM. Militarily, they relay tactical communications and provide another source of intelligence, surveillance, and reconnaissance (ISR) data. Unlike GEO vehicles that recharge their batteries using solar power most of the time, LEO space vehicles experience solar eclipses 15 times per day up to 35 minutes each. As a result, the batteries go through more than 5,000 charge/discharge cycles per year shortening their lifetime. LEO vehicles are usually much smaller reducing available battery power.

Cipher communications can significantly aid LEO SATCOM vehicle power consumption since transmission of messages is reduced by 99% of the time as compared to constant bit streams. Commercially, internet traffic may be transmitted from LEO to the ground via pings calculating the frames of the network traffic carrying internet protocol (IP) packets, for example entire Gbe frames carrying IP packets making switching and routing easy to manage at the endpoints.

Militarily, cipher communications can be used to transmit strategic military messages such as NC3 EAMs; operational intelligence such as Integrated Broadcast Service messages; or tactical data such as Link 16 tactical data link traffic. The LEO vehicle picks up the traffic while flying over friendly countries such as the United States and then transmits the military data while passing over the area of operations (AOR). Since the timing and frequency will be difficult to determine until the pings are transmitted, terrestrial receivers will be difficult to interfere with. If military ground equipment wants to transmit messages to the LEO satellite passing over, using cipher communications they can do so with limited probability of detection and geolocation by adversaries since the pings are short and maybe used across multiple frequencies.

### Space—5G NTN Scenario

In recent years 5G non-terrestrial networks (5G NTN) have demonstrated emergency communications from cell phones to space (both GEO and LEO SATCOM) when outside of cellular service areas. These signals range from 22 kbps uplink and 250 kbps downlink and are significantly limited by link budget of the signal protocols.

Cipher communications can significantly change the effective throughput since it will not be limited by link budget in the same way. Short, higher-power pings will go further and consume 99% less energy than a constant bit stream. Data throughput increases without penalty by spreading the pings further in time and expanding the cipher frames to accommodate larger amounts of data. The pings will use less energy on the cell phone and on the satellite.

### Space—Cislunar Space and Beyond Scenario

Historically, communications in the cislunar region (between geosynchronous orbit and the moon, moon surface, and lunar orbit out to 550,000 km) have been in the VHF, UHF, and S bands of the communication spectrum. Unified S-band (USB) (51.2 Kbps) has been the primary communications band and protocol used with some use of Ka band (100 Mbps) on recent missions. The moon's average distance is 384,4399 km and interesting Lagrange points as far as 300 million km from earth. These distances make link budgets a challenge to maintain. Replacing a constant, low-data rate, bit stream with high-power, pulse energy pings from a cipher communications system will increase assurance of communications receipt in as compared to the energy spread across the modulated bit stream over a much longer period of time. Energy consumption due to onboard computing of the message is traded with the energy consumed in the amplifier TX/RX chains and should be much less. Cipher communications for space eliminates Shannon limits due to link budget and relies on Moore's law, CPU speed (FLOPS), and energy consumed per FLOP.

While the present invention has been described in terms of preferred embodiments, the reader should consider these described embodiments only as particular embodiments. Many other embodiments are possible. Therefore, the reader should determine the scope of the present invention by the claims and their legal equivalents.

What is claimed is:

1. A cipher communication system, comprising:
A. a transmitting message source system programmed to receive, store and transmit a message,
B. a transmission cipher communications processor programmed to receive said message from said message source system and programmed to mathematically transform said message into a ping for transmission,
C. a radio transmitter for receiving said ping from said transmission cipher communications processor,
D. a transmit antenna for receiving said ping from said radio transmitter and transmitting said ping,
E. a receiving antenna for receiving said ping from said transmit antenna,
F. a radio receiver for receiving said ping from said receiving antenna,
G. a receiving cipher communications processor programmed to receive said ping from said radio receiver and programmed to mathematically re-generate said message based on said ping, and
H. a receiving message source system programmed to receive and store and disseminate said message.

2. The cipher communication system as in claim 1, wherein said transmission cipher communications processor and said receiving cipher communications processor both utilize mathematical calculations to generate and encrypt said ping for said transmission and to receive and decrypt said ping for said dissemination.

3. The cipher communication system as in claim 1 wherein said message is a voice massage.

4. The cipher communication system as in claim 1, wherein said message is a video message.

5. The cipher communication system as in claim 1, wherein said message is a data message.

6. The cipher communication system as in claim 1, further comprising the utilization of message padding, protocol bytes, encryption, and error correction coding.

7. The cipher communication system as in claim 1, wherein said ping is a very short duration ping.

8. The cipher communication system as in claim 1, wherein said cipher communication system is utilized for surface maritime communications.

9. The cipher communication system as in claim 1, wherein said cipher communication system is utilized for terrestrial communications.

10. The cipher communication system as in claim 1, wherein said cipher communication system is utilized for airborne communications.

11. The cipher communication system as in claim 1, wherein said cipher communication system is utilized for subsea communications.

12. The cipher communication system as in claim 1, wherein said cipher communication system is utilized for space communications.

13. The cipher communication system as in claim 1, wherein said cipher communication system is utilized for RX communications.

14. The cipher communication system as in claim 1, wherein said cipher communication system is utilized for optical free space communications.

15. The cipher communication system as in claim 1, wherein said cipher communication system is utilized for optical fiber cable communications.

16. The cipher communication system as in claim 1, wherein said cipher communication system is utilized for underwater acoustic communications.

17. The cipher communication system as in claim 1, wherein said cipher communication system is utilized for audible acoustic in-air communications.

18. The cipher communication system as in claim 1, wherein said cipher communication system is utilized for visual communications.
